(19) United States
(12) Patent Application Publication
(10) Pub. No.: US 2003/0009689 A1
(43) Pub. Date: Jan. 9, 2003

(54) Firewall traversing messaging protocol

(76) Inventor: Michael Kolb, Richmond, CA (US)

Correspondence Address: GARY CARY WARE & FREIDENRICH LLP, 1755 EMBARCADERO ROAD, PALO ALTO, CA, 94303-3340, US

(21) Appl. No.: 09/891,586

(22) Filed: Jun. 25, 2001

(51) Int. Cl. G06F 15/173

(52) U.S. Cl. 713/201; 709/227

(57) ABSTRACT

The invention provides peer-to-peer messaging techniques in a networked environment such as the Internet that involves a firewall. In accordance with one preferred aspect of the invention there is provided an agent and a router. In accordance with another preferred aspect of the invention, participating agents register with a router. After a registration, each agent is assigned a unique ID by the router connected to it. A receiving agent protected by a firewall establishes a connection with the router by initiating a communication with the router through the firewall. A sending agent sends a message to the receiving agent by first forwarding the message to the router connected to the sending agent. The invention allows the nodes in a network not only to send messages to other nodes through the firewall, but also to receive messages from other nodes through the firewall. The invention also allows anonymous messaging by enabling a sending agent to initiate a connection to a router and use the connection to send messages to or receive messages from other agents. A router may not include an sending agent's IP address, or other information that may reveal identification of the sending agent, in routed messages in order to protect anonymity of the sending agent.

### FIELD OF THE INVENTION

This invention relates generally to message communication techniques. More specifically, the invention relates to message communication techniques for traversing firewalls.

### BACKGROUND OF THE INVENTION

The Internet has made large amounts of information available to the average computer user at home, in business, and in education. For many people, having access to this information has become an essential need. Yet connecting a private network to the Internet can expose critical or confidential data to malicious attack from anywhere in the world. Thus, private and public networks use firewalls in order to protect both individual computers and corporate networks from hostile intrusion from the Internet.

A firewall can protect networked computers from intentional hostile intrusion that could compromise confidentiality or result in data corruption or denial of service. A firewall may be a hardware device or a software program running on a secure host computer, or a combination of both hardware and software. A firewall typically has at least two network interfaces, one for the network it is intended to protect, and one for the network it is exposed to. A firewall sits at the junction point or gateway between the two networks, typically a private network and a public network such as the Internet. By segmenting a network into different physical subnetworks, firewalls can limit the damage that could spread from one subnet to another.

A typical firewall examines all traffic routed between the two networks to see if it meets certain criteria. If it does, the traffic is routed between the networks, otherwise it is stopped. A firewall may filter both inbound and outbound traffic. Firewalls can filter packets based on their source and destination addresses and port numbers, known as address filtering. For example, firewalls can be configured to grant access to specific ports having well-known numbers, e.g., port 25, which is commonly reserved for the Simple Message Transport Protocol (SMTP, or common e-mail), or port 80, which is commonly reserved for the Hypertext Transport Protocol (HTTP). Firewalls also watch the traffic on the allowed port connections, ensuring that it obeys the protocols of the respective ports. For example, only traffic compliant to SMTP is allowed to and from port 25, and only traffic compliant to the HTTP protocol is allowed to and from port 80. This is known as protocol filtering because the decision to forward or reject traffic is dependant upon the protocol used. Protocol filtering ensures that, to the best extent possible, messages going through firewalls are used only for their intended purpose.

Although firewalls provide benefits to the users, they may also impose severe limitations on the use of a network. Firewalls may prevent the establishment of a connection from a host outside the firewall to hosts inside the firewall. In some cases, they may also prevent the establishment of a connection from a host inside the firewall to hosts outside the firewall. For example, the firewalls may allow only HTTP connections to a host on port 80 for web traffic, but not allow other communications. When a host attempts to communicate with another host using a TCP/IP (Transport Control Protocol/Internet Protocol), a connection has to be established from the sending host to the receiving host in order to send a message from one host to another using the TCP/IP protocol. However, a communication using the TCP/IP protocol may not be possible with a firewall if they cannot be directly connected with each other because either or both of the hosts are behind a firewall that only allow outbound connections on specific ports.

Further, in a peer-to-peer system, virtually no host from outside a firewall can initiate arbitrary communication with another host inside the firewall. In many circumstances, even if a host inside the firewall can initiate a communication with another host outside the firewall, the firewall will often terminate the connection after a period of inactivity. Thus, firewalls may block the ability for peers to communicate effectively and reliably.

Conventional solutions to circumvent the problems posed by firewalls include: Firewall configuration; polling; external mailbox; and E-mail. Firewall configuration allows communications among hosts using a pre-defined and agreed-upon port number and protocol. However, the managers of the firewalls often do not understand the technology sufficiently and are reluctant to make the changes due to potential security concerns. A host inside a firewall could periodically open a connection to each of its potential partner hosts outside of the firewall and query the hosts. However, if the polling periods are long, communication is delayed. If the polling periods are short, there is a high communication and processing overhead in constantly establishing the new connections. In an external mailbox system, each host may have an associated program (mailbox) running outside of the firewall hosted by, e.g. an ISP (Internet Service Provider), to which it periodically connects in order to receive any incoming messages. However, establishing mailboxes, and the corresponding routing between mailboxes requires a substantial investment in the infrastructure, and message delivery is relatively slow. The hosts in the network may also use SMTP (e-mail) as a protocol, as typical firewalls allow SMTP messages to traverses in both directions. However, each mailbox requires configuration by the e-mail administrators, and may require prohibitively high processing overhead. Also, SMTP is potentially slow because it relies on a store-and-forward mechanism, thus requiring messages to make multiple hops to reach a destination.

In addition, each packet sent over the Internet contains information about its originating host. Because the address of the source host can be traced by anyone along the path the packet travels, the originator of the packet is subject to the risk of being discovered by a third party in a conventional network communication system. Because anonymity is not guaranteed on the Internet while exchanging messages, users are prevented from using some applications that require a certain level of privacy or that would reveal the identity (e.g., the host/IP address) of the message originator.

In view of the foregoing, it is highly desirable to provide a communication technique that allows a two-way peer-to-peer messaging in the network protected by firewalls. It is also desirable to provide a communication technique that allows a host to connect directly to other hosts in the network in the presence of firewalls. It is further desirable to provide a communication technique that allows hosts to maintain anonymity while exchanging messages.

### SUMMARY OF THE INVENTION

The invention provides peer-to-peer messaging techniques in a networked environment such as the Internet that involves a firewall. In accordance with one preferred aspect of the invention there is provided an agent and a router. The agent may be implemented by a host computer or a node in the network using software, hardware, or a combination thereof in order to perform message communications. The router implements routines for receiving messages from agents and forwarding them to other routers or receiving agents.

In accordance with another preferred aspect of the invention, participating agents register with a router. The agents have information regarding the address of the connecting router. After a registration, each agent is assigned a unique ID by the router connected to it. A receiving agent protected by a firewall establishes a connection with the router by initiating a communication with the router through the firewall. A sending agent sends a message to the receiving agent by first forwarding the message to the router connected to the sending agent. The router connected to the sending agent receives the message and forwards the message to the receiving agent if the receiving agent is local. Otherwise the router forwards the message to other routers for further routing until the message reaches the receiving agent. In a preferred embodiment of the invention, the message is forwarded to one router in order to minimize the number of hops the message takes.

The invention allows the nodes in a network not only to send messages to other nodes through the firewall, but also to receive messages from other nodes through the firewall. Thus, unlike conventional network systems, the invention allows two-way communication traffic through a firewall. The invention also allows anonymous messaging by enabling a sending agent to initiate a connection to a router and use the connection to send messages to or receive messages from other agents. Anonymity of the sending agent is protected, because the router does not include the sending agent's IP address, or other information that may reveal identification of the sending agent, in the routed message.

### BRIEF DESCRIPTION OF THE DRAWINGS

FIG. 1 illustrates a network 100 comprising a plurality of nodes, a plurality of routers, and a firewall that can be used in conjunction with the invention;

FIG. 2 is a flowchart illustrating a process for establishing a connection for a node in the network 100;

FIG. 3 is a flowchart illustrating processing steps for the router 111 for registering an agent in the network 100; and

FIG. 4 is a flowchart illustrating processing steps for a communication between two agents in the network 100.

### DETAILED DESCRIPTION OF A PREFERRED EMBODIMENT

The invention provides peer-to-peer messaging techniques in a networked environment such as the Internet that involves a firewall. It will be appreciated, however, that the invention may have greater utility, and is applicable to other types of applications on the Internet, such as for general communications in the absence of firewalls and anonymous peer-to-peer messaging in general. The invention is also applicable to all types of networks including peer-to-peer architecture and client-server architecture. To understand the peer-to-peer messaging techniques in accordance with the invention, the basic system of the invention will first be described. Then, the application of the peer-to-peer messaging techniques will be described in conjunction with a network having firewalls.

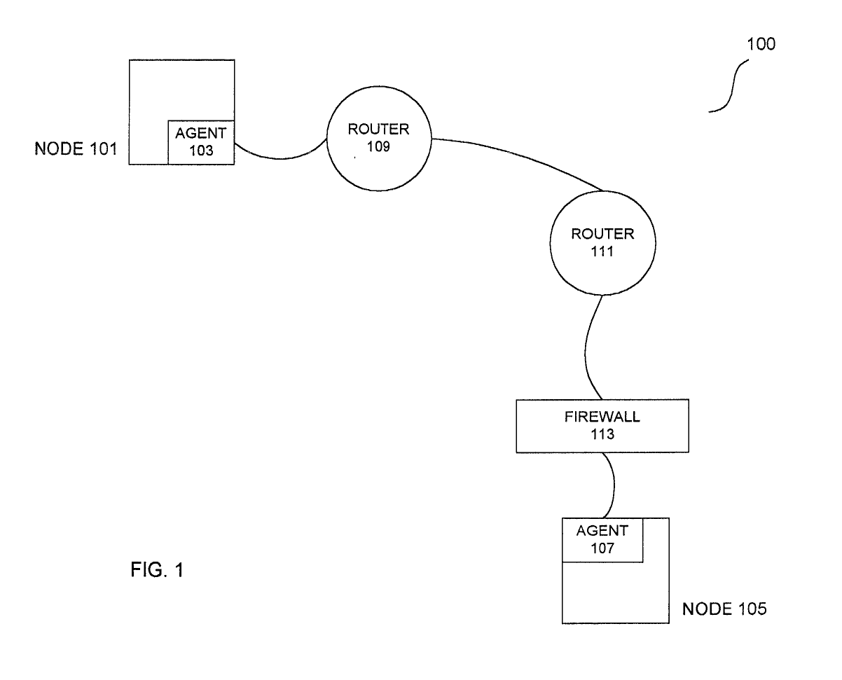

FIG. 1 illustrates a network 100 comprising a plurality of nodes, a plurality of routers, and a firewall that can be used in conjunction with the invention. In FIG. 1, the nodes 101 and 105 may be implemented using a host computer such as a PC (personal computer), a workstation or a server. The nodes 101 and 105 comprise software agents 103 and 107, respectively. A software agent comprises a computer program that can accept tasks and perform steps to achieve the tasks without human intervention. A software agent may make decisions and perform various functions based on data stored in a database. In an alternate embodiment, the agents 103 and 107 may be implemented using hardware or a combination of software or hardware. If implemented using software, any appropriate computer language may be used to implement the agent. For example, C or Java™ language may be used to implement an agent in software. In FIG. 1, the agents 103 and 107 enable the message passing between nodes (host computers).

The routers 109 and 111 may have other nodes and firewalls coupled to them (not shown), as well known in the art. The routers 109 and 111 may be implemented using software or hardware or a combination of both. If software is used to implement the routers, the routers 109 and 111 may comprise a set of software programs that accept connections from agents and forward messages to agents.

In FIG. 1, the node 105 is protected by a firewall 113. The firewall 113 is coupled to the node 101 through routers 111 and 109. Any well-known systems or methods may be used to implement the firewall 113. The firewall 113 may perform protocol filtering and direction filtering. For example, the firewall 113 may allow HTTP outbound connections, and SMTP inbound and outbound connections, but reject HTTP inbound connections.

In operation, the node 105 can send messages to other nodes because the firewall 113 does not prevent outbound messages. The node 105 can receive messages from other nodes through the firewall 113 in the following manner. Before receiving the messages from the router 111, the agent 107 establishes a connection with the router 111. A sending agent such as the agent 103 sends a message to the agent 107 by sending the message along with the receiving agent's id to the router such as the router 109. The sending agent has information about the id of the receiving agent. There are various ways to obtain the information about the receiving agent. Network managers may create a database having such information in the sending agent's computer when the network is configured. Alternatively, such information may be obtained after network configuration by the sending agent polling other agents or directory resources on the network for information necessary to create its database.

The router 109 receives the message from the sending agent 103, and forwards the message to the receiving agent if the receiving agent is connected to the same router. In this example, because the agent is not connected to the router 109, the router routes the message to the next hop or the router 111, which in turn forwards the message to the receiving agent 107. In a preferred embodiment of the invention, information about the address of the router to which the receiving agent is connected, in this case router 111, is embedded in the ID of the receiving agent, as described below. The router 109 may extract and use this information in order to forward the message to the router to which the receiving agent is connected.

The firewall 103 does not reject the incoming message from reaching the agent 107 because an open communication channel has already been established between the router 111 and the agent 107. Generally, once a node or a host computer establishes an open communication channel with other node, the node can communicate with the other node via this channel without being interfered by a firewall. Preferably, the routers 109 and 111 have routing information for other routers and local agents connected to them so that the routers can send messages to each other and agents. The routing information may include addresses of other routers in the network and optimal or shortest path information, as is well-known in the art.

Thus, the invention allows the node 105 not only to send messages to other nodes through the firewall 113, but also to receive messages from other nodes through the firewall 113. This is in contrast to conventional network architecture, in which incoming messages from other nodes in the network are prevented by the firewall 113 from reaching the node 105 unless the messages are a reply to a communication initiated by the node 105. Unlike conventional network systems, the invention allows two-way communication traffic through a firewall.

The invention also allows anonymous messaging by enabling a sending agent to initiate a connection to a router and use the connection to send messages to or receive messages from other agents. Preferably, a router assigns each connecting agent a unique identifier so that the router can identify each agent based upon their IDs. Preferably, a router does not include an originating agent's IP address, or other information that may reveal identification of the originating agent, in routed messages when it routes messages to other routers or receiving agents in order to protect anonymity of the originating agent.

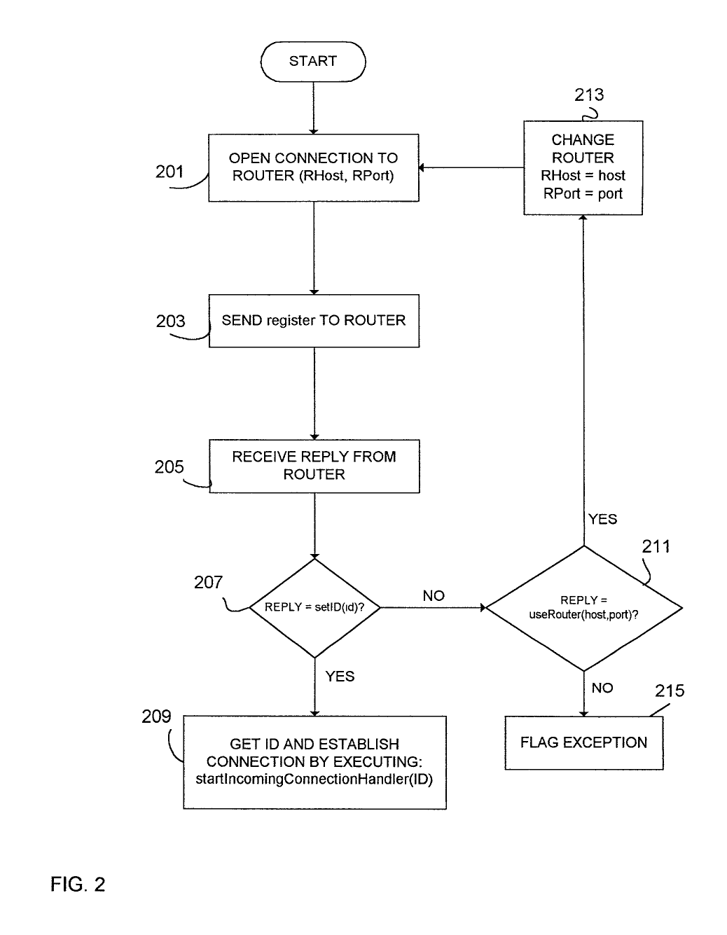

FIG. 2 is a flowchart illustrating a process for establishing a connection for a node in the network 100. In FIG. 2, a node such as the node 105 opens a connection to a router such as the router 111 through the firewall 113 in step 201. The firewall 111 does not prevent the initiation by the node because the communication is initiated from behind the firewall. Preferably, the node 105 uses the agent 107 to handle communication needs. Any suitable message transport protocol may be used to establish communication between the node 105 and the router 111. For example, TCP/IP or UDP (User Datagram Protocol) may be used to send messages and establish communication links. Preferably, the information sent by the sending node comprises RHost and Rport in step 201.

In step 203, the agent 107 of the node 105 sends a register request to the router 111. In response, the router 111 registers the agent 107 in its database and sends a reply, which is received by the agent 107 in step 205. The router 111 may create a unique agent ID for the agent 107 by using makeID( ). Function makeID( ) is used to create an agent number and ID. An agent ID (identifier) may comprise a router host address and port address as well as an additional number to uniquely identify the agent in the context of its router. The unique agent number may be unique in the context of a particular router, or may be made unique in the context of a plurality of routers. Table 1 illustrates a format of an agent ID in accordance with one embodiment of the invention.

TABLE 1

| Bytes | Description |
|---|---|
| 0-7 | Router IP address |
| 8-11 | Router port address |
| 12-19 | Agent number |
| 20-27 | Timestamp when agent ID was issued |

The RHost and RPort denote an IP address of a local router or a router that can forward the message to a destination agent based on the agent number. An agent is considered as local to a router if the agent is visible or directly coupled to the router so that a message can be routed to the agent without involving another router. It will be apparent to one skilled in the art that other embodiments may be used to implement an agent ID. For example, additional fields may be added or some fields may be removed from that shown in Table 1. Preferably, an agent ID remains valid until the agent process is terminated.

If the reply from the router is setID(id) in step 207, the registration is successful and the agent 107 gets an ID issued by the router 111, and establishes an open communication channel with the router 111 by executing startIncomingConnectionHandler in step 209. Function setID(id) is used by a router as an indication that an agent ID has been successfully set up and carries the agent ID as a parameter. The connection between the router 111 and agent 107 is maintained until it is terminated or lost. If the connection between the agent 107 and the router 111 is lost after initial establishment due to some reasons such as network failure or firewall timeouts, the agent 107 may try to re-establish the connection to the router 111 with its previously assigned ID. Thus any information on the network that is related to the agent's ID does not have to be updated.

If the reply is not setID(id) in step 207, the registration is unsuccessful and the agent 107 determines whether the reply is useRouter(host, port) in step 211. host and port together denote an IP address of a router or a node in the network 100. If the reply is useRouter(host, port), the agent 107 changes the address of router to that of the new router in step 213 and returns to step 201, where it opens a new communication with the new router. Otherwise, the agent 107 flags an exception in step 215 to signal an error. Preferably, the address of a router comprises a router's network address and a port address.

Function startIncomingConnectionHandler is used to monitor the connection for, and read, incoming messages from the router. Preferably, startIncomingConnectionHandler spawns a separate thread that loops over a blocking read on the connection to monitor and read incoming messages. Alternatively, startIncomingConnectionHandler may initiate a non-blocking read on the connection and read incoming messages upon arrival.

As illustrated in Table 1, the invention excludes an originating agent's IP address, or other information that may reveal identification of the originating agent, from the agent ID in order to protect the anonymity of the originating agent and enable an anonymous messaging. The IP address of the originating agent is unnecessary for routing a message because an agent number identified in the agent ID is sufficient for a router to route a messages to a destination agent. Preferably, a message may be routed or forwarded by a router based on the IP address of the local router of the destination (receiving) agent until the message reaches the local router. The local router has information necessary for routing the message to the receiving agent.

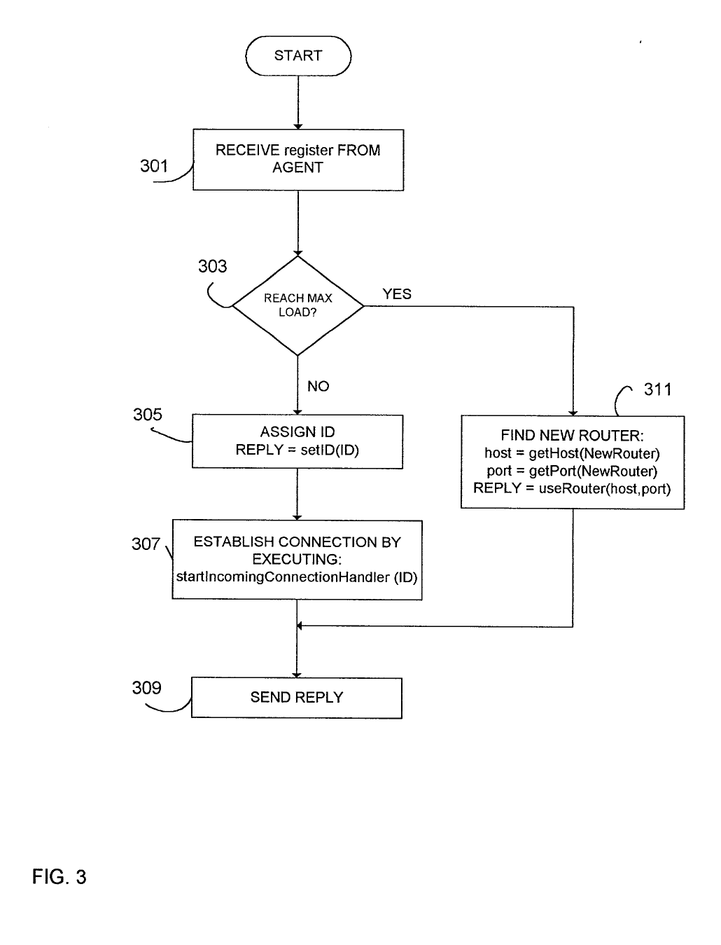

FIG. 3 is a flowchart illustrating processing steps for the router 111 for registering an agent in the network 100. In FIG. 3, the router 111 receives a register request from an agent such as the agent 107 in step 301. The router 111 determines whether it reached its maximum capacity in step 303. Preferably, the router 111 is designed to support a limited number of agents directly connected to it because of limited hardware and software resources. Thus, when an agent connects to the router 111 and the router 111 has reached its load limit to support agents, the connection request from the agent is re-directed to another router in the network to which it can establish a direct connection.

If the router 111 reached its maximum capacity, the router 111 finds a new router in step 311, and sends the address of the new router as its reply in step 309. There are various ways to obtain the information about the new router. Network managers may create a database having such information in the router's computer when the network is configured. Alternatively, such information may be obtained after network configuration by the router polling other routers or directory resources on the network for the necessary information. If the router 111 has not reached its maximum capacity, the router assigns an ID for the agent and prepares a reply comprising the ID in step 305. In step 307, the router 111 establishes a connection with the agent, and sends the reply back to the agent in step 309.

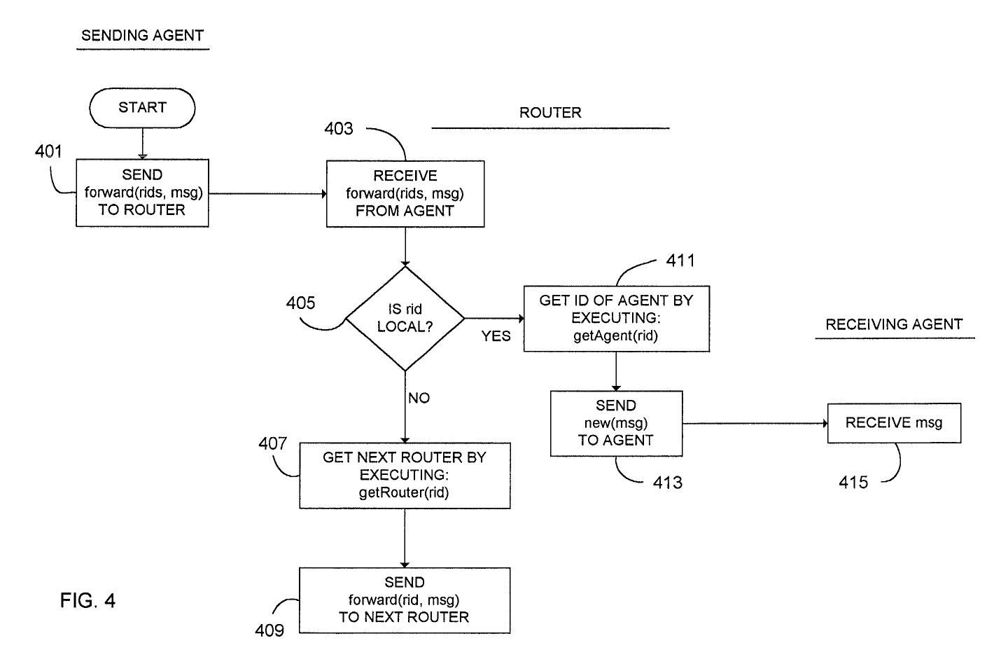

FIG. 4 is a flowchart illustrating processing steps for a communication between two agents in the network 100. In FIG. 4, an originating agent such as the agent 103 initiates a communication with one or more receiving agents such as the agent 107 by sending forward(rids, msg) to a router in step 401. rids is an array of rid identifying the IDs of receiving agents. Preferably, the ID of the agent 107 has information about the address of a router to which the agent 107 is connected, and which can forward messages to the agent 107. Also, the originating agent may send its own agent ID with the message content in order to allow the receiving agent to reply to the originating agent. The invention allows to send a message to multiple receiving agents by forwarding multiple addresses, rids, to a router. The router may then sequentially process or parallel-process the messages in order to route to all receiving agents.

In step 403, the router receives forward(rids, msg) from the originating agent, and determines whether an rid of the rids is a local address. An rid is a local address if the receiving agent denoted by the rid is visible or directly coupled to the router so that msg can be routed to the agent without involving another router.

If a broadcast is desired, the sending agent may use forward(local, msg) or forward(all, msg) so that the message is broadcast to all agents connected to the router or to all agents connected to all routers, respectively. For example, a broadcast message may be necessary when the address of a particular receiving agent is unknown, or if a message needs to be quickly communicated to many agents at once.

If the rid is a local address in step 405, the router gets the address of the agent in step 411, and sends msg to the agent in step 413. If the rid is not a local address, the router needs to find another router to route msg. Thus, in step 407, the router obtains the address of another router in step 407, and sends forward(rid,msg) to the new router in step 409 so that msg can be further routed until it reaches its final destination. Any well-known methods can be used to find other routers in step 407. For example, each router in the network may maintain a database of other routers in the network. Alternatively, a router may find other routers by polling.

The receiving agent receives msg in step 415. In one embodiment of the invention, the receiving agent establishes and maintains an open communication channel with a local router so that the local router can send messages to the receiving agent through a firewall. Alternatively, the receiving agent may periodically or non-periodically poll the local router to determine whether the router has a message for the receiving agent without maintaining a connection with the local router. When the local router has a message for the receiving agent, the receiving agent may instruct the router to start sending the message to the receiving agent.

Preferably, the format of the actual messages exchanged between agents and routers follows the protocol format associated with the well-known port on which the connection is initiated. In one embodiment of the invention, the connection between the agent and the router is initiated on Port 80 using the HTTP standard. Alternatively, the connection between the agent and the router may be initiated on Port 25 and use the SMTP standard for the format of the messages. Typical firewalls allow outbound HTTP messages to pass through protocol-filtering. Firewalls typically do not prevent communications on the World Wide Web using the HTTP because the request for information from the Web is initiated by a user or by a host (web client) behind the firewall. A host can establish an open communication channel with a web server and request the information via this connection. When the web server delivers the information, the host then may close the connection and presents the information to the user. The host may maintain the connection if further communication is desired with the web server. In one embodiment of the invention, agents may use the HTTP-POST format to send messages to the router. Table 2 illustrates formats of various messages that may be used by the agents and routers in the network 100.

TABLE 2

| | FORMAT OF HTTP | |
|---|---|---|
| Process | MESSAGE | |
| register | POST agent HTTP/1.0\r\n | |
| | Content-Length: 0\r\n | |
| | Content-Type: bin\agents\r\n | |
| | \r\n | |
| setID(id) | HTTP/1.0 200 OK\r\n | |
| | Content-Length: 28\r\n | |
| | Content-Type: bin\agents\r\n | |
| | \r\n | |
| | id | |
| useRouter | HTTP/1.0 302 OK\r\n | hl & pl are the byte lengths |
| (host, port) | Content-Length: hl+pl+1\r\n | of host & port, respectively. |
| | Content-Type: bin\agents\r\n | |
| | \r\n | |
| | host: port | |
| forward | POST rid0, rid1, rid2, . . . | rids is an array of IDs. |
| (rids, msg) | HTTP/1.0\r\n | ridn is the nth element of |
| | Content-Length: ml\r\n | rids. |
| | Content-Type: bin\agents\r\n | ml is the byte length of |
| | \r\n | msg. |
| | msg | |
| new(msg) | HTTP/1.0 200 OK\r\n | |
| | Content-Length: ml\r\n | ml is the byte length of |
| | Content-Type: bin\agents\r\n | msg. |
| | \r\n | |
| | msg | |

Table 3 illustrates functions used by the agents and routers in the network 100 in accordance with one embodiment of the invention.

TABLE 3

| Function | Description |
|---|---|
| GetRouter(id) | Returns host:port, where host and port are the |
| | 0-7^{th} and 8-11^{th} characters of id, respectively. |
| getHost(id) | Returns the 0-7^{th} characters of id. |
| getPort(id) | Returns the 8-11^{th} characters of id. |
| getAgent(id) | Returns the 12-19^{th} characters of id. |
| startIncoming | Starts a connection handler listening for HTTP |
| ConnectionHandler | messages from getRouter(id). |
| (id) | |
| maxLoadReached() | Returns true or false depending if the router is |
| | able to accept more connections. |
| makeId() | Returns an ID, which is a 28 byte long string of |
| | hexadecimal characters: 0-7: the IP address of the |
| | router; 8-11: the port number of the router; 12-19: |
| | an arbitrary unique number corresponding to the |
| | agent on the router; 20-27: the timestamp in seconds |
| | when the ID is issued. |
| isIdLocal() | Returns true or false depending if getHost (id) and |
| | getPort (id) are the same host and port of this router. |
| msg(rid, msg) | HTTP/1.0 200 OK\r\n |
| | Content-Length: ml\r\n |
| | Content-Type: bin\agents\r\n |
| | \r\n |
| | msg |

Thus, the invention overcomes problems associated with firewall traversing by using commonly available protocols. The invention does not require any major modifications to or configuration of existing firewall software, and allows for completely anonymous communications, if desired. The invention is also relatively easy to install and maintain. The installation and maintenance may be achieved by one entity or by a number of companies in a collaborative or competitive environment.

The foregoing descriptions of preferred embodiments of the invention are presented for purposes of illustration description. However, it will be appreciated by those skilled in the art that variations of these embodiments may be made without departing from the spirit and scope of the invention, the scope of which is defined by the appended claims.

1. A message communication protocol for traversing a firewall in a network comprising at least one router and at least one firewall and a plurality of nodes comprising a first node protected by said firewall, said protocol comprising:
registering a first node with a router;
registering a second node with said router;
initiating by said first node a first connection between said first node and said router through said firewall;
initiating by said second node a second connection between said second node and said router;
maintaining said first connection between said first node and said router;
sending a message from said second node to said router;
sending said message from said router to said first node; and
receiving said message at said first node.

2. The protocol of claim 1, wherein said first node comprises a first agent and said node comprises a second agent for sending and receiving messages.

3. The protocol of claim 2, wherein said router assigning a first ID and a second ID to said first and second software agents, respectively.

4. A message communication protocol for traversing a firewall in a network comprising at least one router and at least one firewall and a plurality of nodes wherein at least one node is protected by said firewall, said protocol comprising:
registering a first node with a router;
registering a second node with said router;
establishing a first connection between said first node and said router;
sending a message for said second node from said first node to said router;
receiving at said router said message;
establishing a second connection between said second node and said router and determining whether there is a message for said second node;
sending said message from said router to said second node; and
receiving said message at said second node.

5. The protocol of claim 4, wherein said first node comprises a first agent and said node comprises a second agent for sending and receiving messages.

6. The protocol of claim 5, wherein said router assigning a first ID and a second ID to said first and second software agents, respectively.

7. A computer program product for communicating in a network comprising at least one router and at least one firewall and a plurality of nodes wherein at least one node is protected by said firewall; the computer program product comprising a computer readable storage medium and a computer program mechanism embedded therein, the computer program mechanism comprising:
instructions for registering a first node with a first router;
instructions for initiating by said first node a first connection between said first node and said first router through said firewall;
instructions for maintaining said first connection between said first node and said first router; and
instructions for receiving a message at said first node, said message is originated from a second node in said network and forwarded by said first router to said first node.

8. The computer program product of claim 7 further comprising:
instructions for registering said second node with a second router;
instructions for initiating by said second node a second connection between said second node and said second router; and
instructions for sending the message from said second node to said second router;

9. The computer program product of claim 8 further comprising: instructions for determining whether to send the message to a router or to said first node.

10. The computer program product of claim 9 further comprising:
instructions for sending said message from said second router to said first node.

11. The computer program product of claim 10 further comprising:
instructions for sending said message from said second router to said first router; and
instructions for sending said message from said first router to said first node.

12. A computer program product for communicating in a network comprising at least one router and at least one firewall and a plurality of nodes, the computer program product for receiving at a first node a message sent by a second node, said first node protected by a firewall coupled to a first router; the computer program product comprising a computer readable storage medium and a computer program mechanism embedded therein, the computer program mechanism comprising:
instructions for establishing a connection between said first node and said first router;
instructions for determining whether there is a message at said first router for said first node;
instructions for transferring said message at said first router to said first node when there is a message in said first router for said first node; and
instructions for receiving said message at said first node.

13. The computer program product of claim 12 further comprising:
instructions for registering said first node with said first router;
instructions for registering said second node with a second router;
instructions for sending a message from said second node to said second router; and
instructions for receiving at said second router said message.

14. The computer program product of claim 13 further comprising:
instructions for determining at said second router whether to send the message to said first router or to store the message in said second router.

15. The computer program product of claim 14 further comprising instructions for determining at said first router whether to send the message to a router or to store the message in said first router.
